(19) United States
(12) Patent Application Publication
(10) Pub. No.: US 2024/0306210 A1
(43) Pub. Date: Sep. 12, 2024

(54) TERMINAL DEVICE TYPE IDENTIFICATION METHOD, BASE STATION, AND STORAGE MEDIUM

(71) Applicant: CHINA TELECOM CORPORATION LIMITED, Beijing (CN)

(72) Inventors: Jing GUO, Beijing (CN); Jianchi ZHU, Beijing (CN); Nanxi LI, Beijing (CN); Xiaoming SHE, Beijing (CN); Peng CHEN, Beijing (CN)

(21) Appl. No.: 18/578,296

(22) PCT Filed: Jul. 6, 2022
(86) PCT No.: PCT/CN2022/104092

§ 371 Date: Jan. 10, 2024

(30) Foreign Application Priority Data
Jul. 13, 2021 (CN) 202110789233.4

(51) Int. Cl. H04W 74/0833

(52) U.S. Cl. CPC H04W 74/0833

(57) ABSTRACT

The present disclosure relates to a method for identifying a terminal device type, a base station, and a storage medium. The method for identifying the terminal device type includes: in an initial random access procedure, acquiring random access preamble information and a transmission data scheduling message sent by a user terminal; and determining whether the user terminal is a reduced capability terminal according to at least one of the random access preamble information and the transmission data scheduling message.

### CROSS REFERENCE TO RELATED APPLICATIONS

The present application is a national phase application under 35 U.S.C. § 371 of International Application No. PCT/CN2022/104092, filed on Jul. 6, 2022, which is based on and claims the benefit of and priority to Chinese Patent Application No. 202110789233.4, filed on Jul. 13, 2021, the entire contents of both of which are hereby incorporated by reference.

### TECHNICAL FIELD

The present disclosure relates to the field of wireless communication technologies and, more particularly, to a method for identifying a terminal device type, a base station, and a storage medium.

### BACKGROUND

In the 3GPP Rel-17 phase, relevant research on Reduced Capability (RedCap) terminals, such as smart wearable devices, surveillance cameras, low-end IoT devices, industrial sensors, etc., are being developed. Compared with common terminals, RedCap terminals have lower requirements for indicators such as a transmission rate and a delay, and have weaker terminal capabilities, including a bandwidth, the number of antennas, the number of downlink Multiple Input Multiple Output (MIMO) streams, a modulation order, a duplex mode, etc., to meet device size requirements and adapt to actual needs of different service scenarios.

### SUMMARY

According to an aspect of the present disclosure, there is provided a method for identifying a terminal device type, including:
acquiring, in an initial random access procedure, random access preamble information and a transmission data scheduling message sent by a user terminal; and
determining whether the user terminal is a reduced capability terminal according to at least one of the random access preamble information and the transmission data scheduling message.

According to another aspect of the present disclosure, there is provided a base station, including:
a memory, configured to store instructions; and
a processor, configured to execute the instructions to cause the base station to perform operations that implement the method for identifying the terminal device type described in any of the above embodiments.

According to another aspect of the present disclosure, there is provided a non-transitory computer-readable storage medium having computer instructions stored thereon which, when executed by a processor, implement the method for identifying the terminal device type described in any of the above embodiments.

### BRIEF DESCRIPTION OF THE DRAWINGS

In order to more clearly illustrate technical solutions in embodiments of the present disclosure or in the related arts, drawings used in the description of the embodiments or the related art will be briefly described below. Understandably, the drawings in the following description are merely some embodiments of the present disclosure. For those skilled in the art, other drawings may also be obtained based on these drawings without paying any creative work.

FIG. 1 is a schematic diagram of a method for identifying a terminal device type according to some embodiments of the present disclosure.

FIG. 2 is a schematic diagram of a contention-based initial random access procedure according to some embodiments of the present disclosure.

FIG. 3 is a schematic diagram of a 2-step initial random access procedure according to some embodiments of the present disclosure.

FIG. 4 is a schematic diagram of a method for identifying a terminal device type according to some other embodiments of the present disclosure.

FIG. 5 is a schematic diagram of a base station according to some embodiments of the present disclosure.

FIG. 6 is a schematic structural diagram of a base station according to some other embodiments of the present disclosure.

### DETAILED DESCRIPTION

The technical solutions in embodiments of the present disclosure will be described clearly and completely with reference to the drawings in the embodiments of the present disclosure, and it is understood that the embodiments described are only some, rather than all, of the embodiments of the present disclosure. The following description of at least one example embodiment is merely illustrative in nature and is in no way intended to limit the disclosure, its application, or uses. All other embodiments, which can be derived by those skilled in the art from the embodiments disclosed herein without inventiveness, are intended to be within the scope of the present disclosure.

The relative arrangement of parts and steps, numerical expressions and numerical values set forth in these embodiments do not limit the scope of the present disclosure unless specifically stated otherwise.

Meanwhile, it should be understood that, for the convenience of description, the sizes of the respective portions shown in the drawings are not drawn in an actual proportional relationship.

Techniques, methods, and devices known to one of ordinary skill in the relevant art may not be discussed in detail but are intended to be part of the specification where appropriate.

In all examples shown and discussed herein, any particular value should be construed as exemplary only and not as limiting. Thus, other examples of the exemplary embodiments may have different values.

It should be noted that: similar reference numbers and letters refer to similar items in the following figures, and thus, once an item is defined in one figure, it need not be discussed further in subsequent figures.

The inventor found through researches that the introduction of RedCap terminals will lead to the emergence of terminal types with different capability levels in a network. In a case that the RedCap terminals and common terminals coexist, if a terminal type cannot be identified as early as possible, resource assignment may be unreasonable and a service quality of a deployed common terminal will be affected.

In view of at least one of the above technical problems, the present disclosure provides a method for identifying a terminal device type, a base station and a storage medium, which can identify a RedCap terminal and a common terminal during an initial random access procedure.

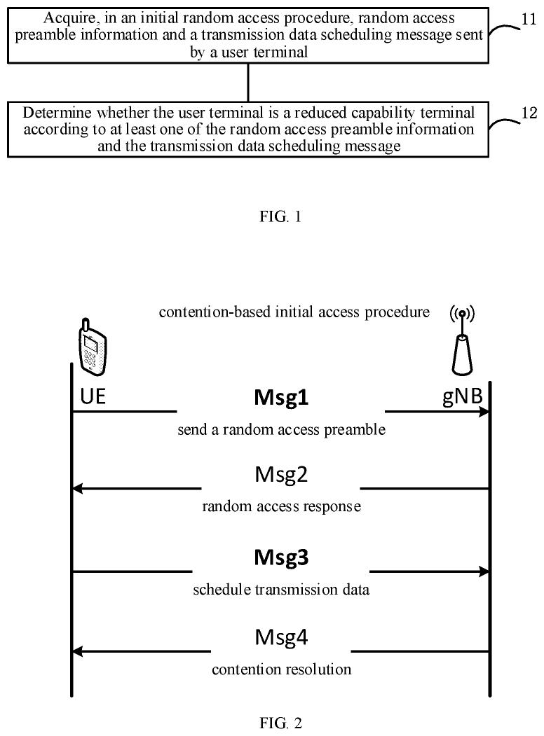

FIG. 1 is a schematic diagram of a method for identifying a terminal device type according to some embodiments of the present disclosure. For example, these embodiments may be performed by a base station (for example, a 5G base station such as gNB) of the present disclosure. The method of embodiments of FIG. 1 may include at least one of steps 11 and 12.

In the step 11, random access preamble information and a transmission data scheduling message sent by a user terminal are acquired in an initial random access procedure.

At this stage, in the initial random access procedure, the RedCap terminal that is identified is the focus of the disclosed technical solution.

FIG. 2 is a schematic diagram of a contention-based initial random access procedure according to some embodiments of the present disclosure. As shown in FIG. 2, in the contention-based initial random access procedure, a message that may be used for identifying the RedCap terminal includes Message1 (Msg1) and Message3 (Msg3). In embodiments of FIG. 2, the random access preamble information is Msg1 sent by the terminal, and the transmission data scheduling message is Msg3 sent by the terminal.

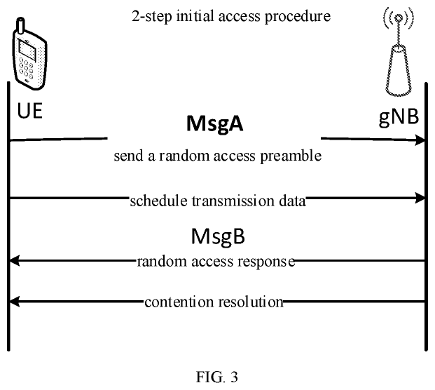

FIG. 3 is a schematic diagram of a 2-step initial access according to some embodiments of the present disclosure. As shown in FIG. 3, for a 2-step Random Access Channel (2-step RACH) procedure, the preamble (Msg1) and the scheduled Physical Uplink Shared Channel (PUSCH) are combined into a single message MsgA. Therefore, in the 2-step initial access procedure, the message that may be used for identifying the RedCap terminal is MsgA. The random access preamble information is a preamble part in a request message (that is, MsgA preamble part) sent by the terminal, and the transmission data scheduling message is an uplink physical shared channel part in the request message (that is, MsgA PUSCH part) sent by the terminal.

The access procedures of embodiments in FIG. 2 and FIG. 3 are essentially the same. Msg1 or Msg3 being used for identifying the RedCap terminal mentioned in the above embodiments of the present disclosure is also applicable to the 2-step RACH, and correspondingly, MsgA preamble part or MsgA PUSCH part is used for identifying the RedCap terminal.

In step 12, it is determined whether the user terminal is a reduced capability terminal according to at least one of the random access preamble information and the transmission data scheduling message.

In some embodiments of the present disclosure, the step 12 may include: determining whether the user terminal is the reduced capability terminal according to the random access preamble information, and acquiring a first determination result; determining whether the user terminal is the reduced capability terminal according to the transmission data scheduling message, and acquiring a second determination result; and determining the user terminal to be the reduced capability terminal in a case that at least one of the first determination result and the second determination result is that the user terminal is the reduced capability terminal.

In some embodiments of the present disclosure, the step 12 of determining whether the user terminal is the reduced capability terminal according to the random access preamble information may include the following steps.

A System Information Block (SIB) message in the random access preamble information is read, and it is determined whether there is a physical random access channel resource index individually defined by the reduced capability terminal in the random access preamble information.

If there is the physical random access channel resource index individually defined by the reduced capability terminal, the user terminal is determined to be the reduced capability terminal.

In a case that the user terminal is determined to be the reduced capability terminal according to the physical random access channel resource index individually defined by the reduced capability terminal, a specific physical random access channel resource is configured for the reduced capability terminal, or a specific preamble is assigned for the reduced capability terminal.

In some embodiments of the present disclosure, configuring for the reduced capability terminal the specific physical random access channel resource may include: configuring, in a time domain, a transmission occasion of a random access channel for the reduced capability terminal, that is, a Time-Division Multiplexing (TDM) mode is configured for the reduced capability terminal.

In some other embodiments of the present disclosure, configuring for the reduced capability terminal the specific physical random access channel resource may include: configuring, in a frequency domain, a transmission occasion of a random access channel for the reduced capability terminal, that is, a Frequency-Division Multiplexing (FDM) mode is configured for the reduced capability terminal.

In some embodiments of the present disclosure, the step 12 of determining whether the user terminal is the reduced capability terminal according to the transmission data scheduling message may include: determining whether a reduced capability terminal identity bit (e.g., a spare bit) in the transmission data scheduling message is valid; and if the reduced capability terminal identity bit in the transmission data scheduling message is valid, determining the user terminal to be the reduced capability terminal.

Based on the method for identifying the terminal device type provided by embodiments of the present disclosure, the RedCap terminal and the common terminal are identified in the initial random access procedure, so that a network can better assign a resource, improving a resource utilization and reducing an impact of the RedCap terminal on the service quality of the deployed common terminal, so as to improve a network performance.

In the present disclosure, the RedCap terminal and the common terminal may be identified in the initial random access procedure.

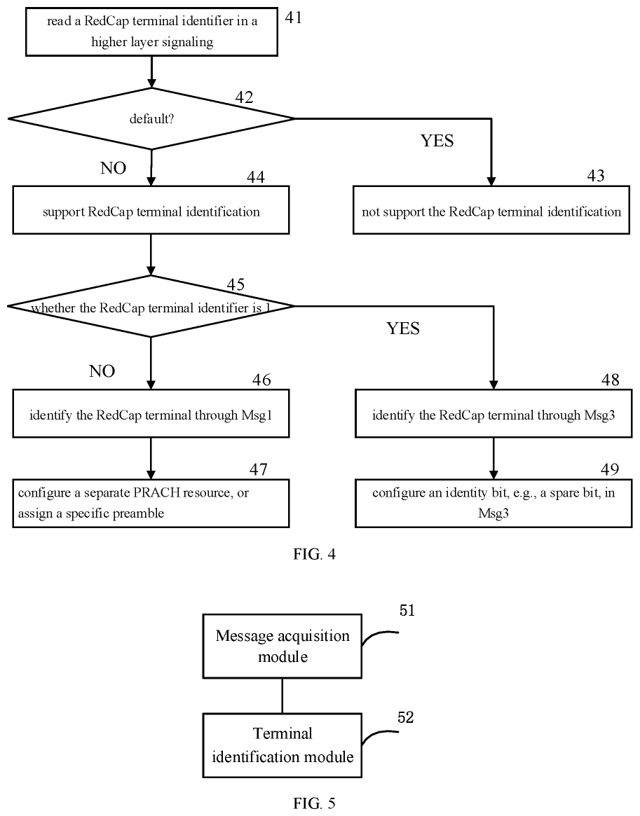

FIG. 4 is a schematic diagram of a method for identifying a terminal device type according to some other embodiments of the present disclosure. For example, these embodiments may be performed by a base station (for example, a 5G base station such as gNB) of the present disclosure. The method of embodiments of FIG. 4 may include at least one of steps 41 to 49.

In the step 41, a reduced capability terminal identifier (RedCap terminal identifier) in a higher layer signaling is acquired.

In some embodiments of the present disclosure, the reduced capability terminal identifier is represented by 1 bit.

In the step 42, it is determined whether the reduced capability terminal identifier is default. In a case that the reduced capability terminal identifier is not default, the step 44 is executed. Otherwise, in a case that the reduced capability terminal identifier is default, the step 43 is executed.

In the step 43, RedCap terminal identification is not supported.

In the step 44, the RedCap terminal identification is supported.

In the step 45, it is determined whether the RedCap identifier is 1. In a case that the RedCap identifier is 1, the step 48 is executed. Otherwise, in a case that the RedCap identifier is 0, the step 46 is executed.

In the step 46, the RedCap terminal is identified in Msg1 of the random access procedure, that is, “0” indicates that the RedCap terminal is identified in Msg1 of the random access procedure.

In some embodiments of the present disclosure, the step 46 of identifying the RedCap terminal through Msg1 may include: reading the SIB message to determine whether there is a a physical random access channel resource index, for example, PRACH-ConfigurationIndex, individually defined by the RedCap terminal; and if there is the physical random access channel resource index individually defined by the reduced capability terminal, determining the user terminal to be the reduced capability terminal.

In the step 47, a separate PRACH resource is configured for the reduced capability terminal or a specific preamble is assigned to the reduced capability terminal, to distinguish the RedCap terminal from the common terminal.

In some embodiments of the present disclosure, a distinguishing manner may include:

A first one: a transmission occasion of a random access channel is configured for the reduced capability terminal in a time domain, that is, a TDM mode is configured for the reduced capability terminal.

A second one: the transmission occasion of the random access channel is configured for the reduced capability terminal in a frequency domain, that is, a FDM mode is configured for the reduced capability terminal.

A third one: a specific preamble sequence is assigned to the reduced capability terminal.

In the step 48, the RedCap terminal is identified in Msg3 of the random access procedure, that is, “1” indicates that the RedCap terminal is identified in Msg3 of the random access procedure.

In some embodiments of the present disclosure, the step 48 of identifying the RedCap terminal through Msg3 includes: reading a RedCap identity bit, that is a spare bit, in Msg3; and if the identity bit is valid, determining the user terminal to be the reduced capability terminal.

In the step 49, the identity bit, for example, the spare bit, in Msg3 is configured to indicate whether the user terminal is the RedCap terminal.

The above embodiments of the present disclosure are also applicable to the 2-step RACH procedure.

Based on the method for identifying the terminal device type provided by embodiments of the present disclosure, it supports identifying the RedCap terminal in Msg1 or Msg3 of the initial random access procedure, which may be flexibly selected and configured by the network side according to actual needs, achieving the purpose of balancing resource overhead and the system performance, while reducing the impact on the service quality of the deployed common terminal.

FIG. 5 is a schematic diagram of a base station according to some embodiments of the present disclosure. As shown in FIG. 5, the base station in the present disclosure may include a message acquisition module 51 and a terminal identification module 52.

The message acquisition module 51 is configured to acquire, in an initial random access procedure, random access preamble information and a transmission data scheduling message sent by a user terminal.

In some embodiments of the present disclosure, in a contention-based initial random access procedure, the random access preamble information is message 1 (Msg1) sent by the terminal, and the transmission data scheduling message is message 3 (Msg3) sent by the terminal.

In some embodiments of the present disclosure, in a 2-step initial access procedure, the random access preamble information is a preamble part in a request message sent by the terminal, and the transmission data scheduling message is an uplink physical shared channel part in the request message sent by the terminal.

The terminal identification module 52 is configured to determine whether the user terminal is a reduced capability terminal according to at least one of the random access preamble information and the transmission data scheduling message.

In some embodiments of the present disclosure, in a case that it is determined whether the user terminal is the reduced capability terminal according to the random access preamble information, the terminal identification module 52 may be configured to determine whether a physical random access channel resource index individually defined by the reduced capability terminal exists in the random access preamble information; determine the user terminal to be the reduced capability terminal if the physical random access channel resource index individually defined by the reduced capability terminal exists; and in a case that the user terminal is determined to be the reduced capability terminal according to the physical random access channel resource index individually defined by the reduced capability terminal, configure for the reduced capability terminal a specific physical random access channel resource, or assigning for the reduced capability terminal a specific preamble.

In some embodiments of the present disclosure, in a case that the terminal identification module 52 configures for the reduced capability terminal the specific physical random access channel resource, the terminal identification module 52 may be configured to configure, in a time domain, a transmission occasion of a random access channel for the reduced capability terminal.

In some other embodiments of the present disclosure, in a case that the terminal identification module 52 configures for the reduced capability terminal the specific physical random access channel resource, the terminal identification module 52 may be configured to configure, in a frequency domain, the transmission occasion of the random access channel for the reduced capability terminal.

In some embodiments of the present disclosure, in a case that it is determined whether the user terminal is the reduced capability terminal according to the transmission data scheduling message, the terminal identification module 52 may be configured to determine whether a reduced capability terminal identity bit in the transmission data scheduling message is valid; and determine the user terminal to be the reduced capability terminal if the reduced capability terminal identity bit in the transmission data scheduling message is valid.

In some embodiments of the present disclosure, the terminal identification module 52 may also be configured to determine whether a reduced capability terminal identifier exists in a higher layer signaling; and in a case that the reduced capability terminal identifier exists in the higher layer signaling, determine that identifying the reduced capability terminal is supported, and then perform the step of determining whether the user terminal is the reduced capability terminal according to the at least one of the random access preamble information and the transmission data scheduling message.

In some embodiments of the present disclosure, the terminal identification module 52 may be configured to determine whether the user terminal is the reduced capability terminal according to the random access preamble information, in a case that the reduced capability terminal identifier bit is 1; and determine whether the user terminal is the reduced capability terminal according to the transmission data scheduling message, in a case that the reduced capability terminal identifier bit is 0.

In some embodiments of the present disclosure, the terminal identification module 52 may be configured to determine whether the user terminal is the reduced capability terminal according to the random access preamble information, and acquire a first determination result; determine whether the user terminal is the reduced capability terminal according to the transmission data scheduling message, and acquire a second determination result; and determine the user terminal to be the reduced capability terminal in a case that at least one of the first determination result and the second determination result is that the user terminal is the reduced capability terminal.

In some embodiments of the present disclosure, the base station may be configured to perform operations that implement the method for identifying the terminal device type described in any of the above embodiments (for example, embodiments of FIG. 1 or FIG. 4).

Based on the base station provided by embodiments of the present disclosure, the RedCap terminal and the common terminal are identified in the initial random access procedure, so that a network can better assign a resource, improving a resource utilization and reducing an impact of the RedCap terminal on the service quality of the deployed common terminal, so as to improve a network performance.

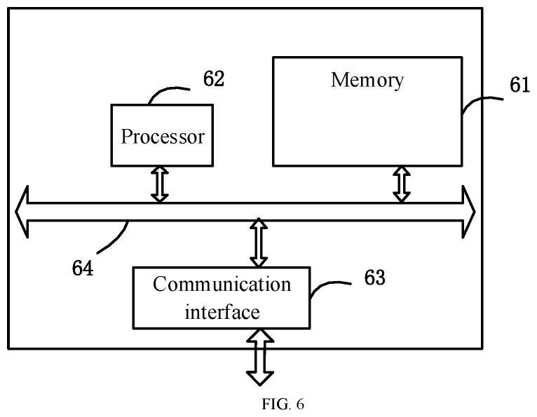

FIG. 6 is a schematic structural diagram of a base station according to some other embodiments of the present disclosure. As shown in FIG. 6, the base station includes a memory 61 and a processor 62.

The memory 61 is configured to store instructions. The processor 62 is coupled to the memory 61, and is configured to execute, based on the instructions stored in the memory, operations that implement the method for identifying the terminal device type described in any of the above embodiments (for example, embodiments of FIG. 1 or FIG. 4).

As shown in FIG. 6, the base station further includes a communication interface 63 configured to exchange information with other devices. In addition, the base station further includes a bus 64, through which the processor 62, the communication interface 63, and the memory 61 complete communication with each other.

The memory 61 may include a high-speed RAM memory, or may also include a non-volatile memory, such as at least one disk memory. The memory 61 may also be a memory array. The memory 61 may also be divided into blocks, and the blocks may be combined into a virtual volume according to certain rules.

In addition, the processor 62 may be a central processing unit (CPU), or may be an application specific integrated circuit (ASIC), or may be one or more integrated circuits configured to implement embodiments of the present disclosure.

Based on the base station provided by embodiments of the present disclosure, it supports identifying the RedCap terminal in Msg1 or Msg3 of the initial random access procedure, which may be flexibly selected and configured by the network side according to actual needs, achieving the purpose of balancing resource overhead and the system performance, while reducing the impact on the service quality of the deployed common terminal.

The above embodiments of the present disclosure are also applicable to the 2-step RACH procedure.

The above embodiments of the present disclosure relate to the field of wireless communication technologies, and in particular to 5G standardization.

According to another aspect of the present disclosure, there is provided a non-transitory computer-readable storage medium having computer instructions stored thereon which, when executed by a processor, implement the method for identifying the terminal device type described in any of the above embodiments (for example, embodiments of FIG. 1 or FIG. 4).

Based on the non-transitory computer-readable storage medium provided by embodiments of the present disclosure, the RedCap terminal and the common terminal are identified in the initial random access procedure, so that a network can better assign a resource, improving a resource utilization and reducing an impact of the RedCap terminal on the service quality of the deployed common terminal, so as to improve a network performance.

Those skilled in the art shall understand that embodiments of the present disclosure may be described in terms of a method, a device, or a computer program product. Therefore, the present disclosure may be implemented by embodiments using pure hardware, pure software, or a combination of hardware and software. In addition, the present disclosure may also employ a computer program product that is implemented on one or a plurality of computer-readable non-transitory storage media (including but not limited to a magnetic disk memory, a CD-ROM, and an optical memory) including computer-readable program codes.

The present disclosure is described with reference to flowcharts and/or block diagrams of the method, device (system), and computer program product according to embodiments of the present disclosure. It can be understood that computer program instructions may be configured to implement each process and/or block in the flowcharts and/or block diagrams, and a combination of processes and/or blocks in the flowcharts and/or block diagrams. These computer program instructions may be provided to a general computer, a dedicated computer, an embedded processor, or processors of other programmable data processing devices to generate a machine to enable the instructions executed by the computer or the processors of other programmable data processing devices to generate a device for implementing functions defined in one or a plurality of processes in the flowcharts, and/or one block or a plurality of blocks in the block diagrams.

These computer program instructions may also be stored in a computer-readable memory capable of booting a computer or other programmable data processing devices to work in a particular manner, such that the instructions stored in the computer-readable memory, when being executed, generate a product including the instruction device, where the instruction device implements functions defined in one process or a plurality of processes in the flowcharts, and/or one or a plurality of blocks in the block diagrams.

These computer program instructions may also be loaded to the computer or other programmable data processing devices, such that a series of operations or steps are performed on the computer or other programmable devices to generate processing implemented on the computer, and the instructions executed on the computer or other programmable devices provides steps of implementing functions defined in one process or a plurality of processes in the flowcharts, and/or one block or a plurality of blocks in the block diagrams.

The base station described above may be implemented as a general-purpose processor, a programmable logic controller (PLC), a digital signal processor (DSP), an application-specific integrated circuit (ASIC), a field-programmable gate array (FPGA) or other programmable logic devices, discrete gates or transistor logic devices, discrete hardware components, or any appropriate combination thereof, configured to perform functions described in the present disclosure.

The present disclosure has been described in detail so far. To avoid obscuring the idea of the present disclosure, some details that are well known in the art have not been described. Based on the above description, those skilled in the art can completely understand how to implement the technical solution disclosed here.

Those of ordinary skill in the art can understand that all or part of steps to implement the above embodiments can be completed by hardware, or can be completed by instructing the relevant hardware through a program. The program may be stored in a non-transitory computer-readable storage medium, which may be a read-only memory, a magnetic disk or an optical disk, etc.

The description of the present disclosure has been presented for the purposes of illustration and description, but is not exhaustive or intended to limit the present disclosure to the disclosed form. Many modifications and variations will be apparent to those of ordinary skill in the art. The embodiments are selected and described for illustrating the principle and actual application of the present disclosure in a better way, and enabling those of ordinary skill in the art to understand the present disclosure and design various embodiments for specific purposes with various modifications.

1. A method for identifying a terminal device type, comprising:
acquiring, in an initial random access procedure, random access preamble information and a transmission data scheduling message sent by a terminal; and
determining whether the terminal is a reduced capability terminal according to at least one of the random access preamble information and the transmission data scheduling message.

2. The method for identifying the terminal device type according to claim 1, wherein determining whether the terminal is the reduced capability terminal according to the random access preamble information comprises:
determining whether a physical random access channel resource index individually defined by the reduced capability terminal exists in the random access preamble information; and
determining the terminal to be the reduced capability terminal in response to determining that the physical random access channel resource index individually defined by the reduced capability terminal exists.

3. The method for identifying the terminal device type according to claim 2, further comprising:
in a case that the terminal is determined to be the reduced capability terminal according to the physical random access channel resource index individually defined by the reduced capability terminal, configuring for the reduced capability terminal a specific physical random access channel resource, or assigning for the reduced capability terminal a specific preamble sequence.

4. The method for identifying the terminal device type according to claim 2, wherein configuring for the reduced capability terminal the specific physical random access channel resource comprises:
configuring, in a time domain, a transmission occasion of a random access channel for the reduced capability terminal; or,
configuring, in a frequency domain, the transmission occasion of the random access channel for the reduced capability terminal.

5. The method for identifying the terminal device type according to claim 1, wherein determining whether the terminal is the reduced capability terminal according to the transmission data scheduling message comprises:
determining whether a reduced capability terminal identity bit in the transmission data scheduling message is valid; and
determining the terminal to be the reduced capability terminal in response to determining that the reduced capability terminal identity bit in the transmission data scheduling message is valid.

6. The method for identifying the terminal device type according to claim 1, further comprising:
determining whether a reduced capability terminal identifier exists in a higher layer signaling; and
in a case that the reduced capability terminal identifier exists in the higher layer signaling, determining that identifying the reduced capability terminal is supported, and then performing the step of determining whether the terminal is the reduced capability terminal according to the at least one of the random access preamble information and the transmission data scheduling message.

7. The method for identifying the terminal device type according to claim 6, wherein determining whether the terminal is the reduced capability terminal according to the at least one of the random access preamble information and the transmission data scheduling message comprises:
determining whether the terminal is the reduced capability terminal according to the random access preamble information, in a case that the reduced capability terminal identifier bit is 1; and
determining whether the terminal is the reduced capability terminal according to the transmission data scheduling message, in a case that the reduced capability terminal identifier bit is 0.

8. The method for identifying the terminal device type according to a claim 1, wherein determining whether the terminal is the reduced capability terminal according to the at least one of the random access preamble information and the transmission data scheduling message comprises:
determining whether the terminal is the reduced capability terminal according to the random access preamble information, and acquiring a first determination result;
determining whether the terminal is the reduced capability terminal according to the transmission data scheduling message, and acquiring a second determination result; and
determining the terminal to be the reduced capability terminal in a case that at least one of the first determination result and the second determination result is that the terminal is the reduced capability terminal.

9. The method for identifying the terminal device type according to claim 1, wherein:
in a contention-based initial random access procedure, the random access preamble information is message 1 (Msg1) sent by the terminal, and the transmission data scheduling message is message 3 (Msg3) sent by the terminal; or
in a 2-step initial access procedure, the random access preamble information is a preamble part in a request message sent by the terminal, and the transmission data scheduling message is an uplink physical shared channel part in the request message sent by the terminal.

10-11. (canceled)

12. A base station, comprising:
a memory, configured to store instructions; and
a processor, configured to execute the instructions to cause the base station to perform the following operations:
acquiring, in an initial random access procedure, random access preamble information and a transmission data scheduling message sent by a terminal; and
determining whether the terminal is a reduced capability terminal according to at least one of the random access preamble information and the transmission data scheduling message.

13. A non-transitory computer-readable storage medium having computer instructions stored thereon which, when executed by a processor, implement the following operations:
acquiring, in an initial random access procedure, random access preamble information and a transmission data scheduling message sent by a terminal; and
determining whether the terminal is a reduced capability terminal according to at least one of the random access preamble information and the transmission data scheduling message.

14. The base station according to claim 12, wherein the processor is further configured to:
determine whether a physical random access channel resource index individually defined by the reduced capability terminal exists in the random access preamble information; and
determine the terminal to be the reduced capability terminal in response to determining that the physical random access channel resource index individually defined by the reduced capability terminal exists.

15. The base station according to claim 14, wherein the processor is further configured to:
in a case that the terminal is determined to be the reduced capability terminal according to the physical random access channel resource index individually defined by the reduced capability terminal, configure for the reduced capability terminal a specific physical random access channel resource, or assign for the reduced capability terminal a specific preamble sequence.

16. The base station according to claim 14, wherein the processor is further configured to:
configure, in a time domain, a transmission occasion of a random access channel for the reduced capability terminal; or,
configure, in a frequency domain, the transmission occasion of the random access channel for the reduced capability terminal.

17. The base station according to claim 12, wherein the processor is further configured to:
determine whether a reduced capability terminal identity bit in the transmission data scheduling message is valid; and
determine the terminal to be the reduced capability terminal in response to determining that the reduced capability terminal identity bit in the transmission data scheduling message is valid.

18. The base station according to claim 12, wherein the processor is further configured to:
determine whether a reduced capability terminal identifier exists in a higher layer signaling; and
in a case that the reduced capability terminal identifier exists in the higher layer signaling, determine that identifying the reduced capability terminal is supported, and then perform the step of determining whether the terminal is the reduced capability terminal according to the at least one of the random access preamble information and the transmission data scheduling message.

19. The base station according to claim 18, wherein the processor is further configured to:
determine whether the terminal is the reduced capability terminal according to the random access preamble information, in a case that the reduced capability terminal identifier bit is 1; and
determine whether the terminal is the reduced capability terminal according to the transmission data scheduling message, in a case that the reduced capability terminal identifier bit is 0.

20. The base station according to claim 12, wherein the processor is further configured to:
determine whether the terminal is the reduced capability terminal according to the random access preamble information, and acquiring a first determination result;
determine whether the terminal is the reduced capability terminal according to the transmission data scheduling message, and acquiring a second determination result; and
determine the terminal to be the reduced capability terminal in a case that at least one of the first determination result and the second determination result is that the terminal is the reduced capability terminal.

21. The base station according to claim 12, wherein:
in a contention-based initial random access procedure, the random access preamble information is message 1 (Msg1) sent by the terminal, and the transmission data scheduling message is message 3 (Msg3) sent by the terminal; or
in a 2-step initial access procedure, the random access preamble information is a preamble part in a request message sent by the terminal, and the transmission data scheduling message is an uplink physical shared channel part in the request message sent by the terminal.
